(19) United States
(12) Patent Application Publication
(10) Pub. No.: US 2015/0338132 A1
(43) Pub. Date: Nov. 26, 2015

(54) Solar Collector System

(71) Applicant: Martin HADLAUER, Graz (AT)

(72) Inventor: Martin Hadlauer, Graz (AT)

(21) Appl. No.: 14/411,426

(22) PCT Filed: Jun. 27, 2013
(86) PCT No.: PCT/EP2013/063296

§ 371 Date: Mar. 18, 2015

(30) Foreign Application Priority Data
Jun. 27, 2012 (DE) 10 2012 211 073.9

(51) Int. Cl. F24J 2/46; G02B 19/00; F24J 2/54

(52) U.S. Cl. CPC F24J 2/4638; F24J 2/4609; F24J 2/461; F24J 2/54; G02B 19/0042

(57) ABSTRACT

An opening and closing module for solar collector installations, characterized in that solar collectors and holding apparatuses form fixed movement units, which are arranged mirror-symmetrically in pairs and are attached via displaceable joints to a support apparatus, which is fixedly or movably attached to a supporting frame. The individual rotary joints at the movement units are positively guided via linear guides or pendulum supports, which are anchored at the support apparatus.

### CROSS-REFERENCE TO RELATED APPLICATION

This application claims the benefit of the filing date of the German Patent Application No. 10 2012 211 073.9, filed 27 Jul. 2013, the disclosure of which is hereby incorporated herein by reference.

### FIELD OF INVENTION

Embodiments of the present invention relate to a solar collector system and in particular a solar collector system with an opening and closing mechanism for solar collectors arranged in pairs, which solar collectors can close together with respect to one another.

### TECHNICAL BACKGROUND

A collector system with mirror-concentrating collectors which are tracked bi-axially is presented in WO 2005 003644. In addition to the bi-axial tracking, the possibility is shown to close the collectors in pairs at the mirror ends. As a result, on the one hand, an effective protection against damaging environmental influences can be achieved, on the other hand, the wind attack area is halved in the protected state. The protective position is particularly important in order to prevent damage in the event of extreme environmental influences (sandstorm, hail, . . . ) and in order to reduce the rate of soiling.

A considerable technical outlay is necessary in order to allow the opening and closing of the collectors in pairs, which should be minimized.

### BRIEF DESCRIPTION OF EMBODIMENTS OF THE INVENTION

There may be a need to provide a solar collector system, in which drive and joint forces for the opening and closing procedure are kept as low as possible and thus the constructional outlay for hydraulic and/or spindle drives as well as for the support apparatus may be kept low.

The object may be solved by means of the solar collector system according to the independent claim. Preferred exemplary embodiments will be described in the dependent claims.

According to an exemplary aspect, a solar collector system with an opening and closing mechanism is provided, the solar collector system comprising solar collectors and an opening and closing mechanism with movement axes, an actuator, and two holding apparatuses arranged mirror-symmetrically with respect to one another in pairs. The holding apparatuses are configured to accommodate one or a plurality of solar collectors in such a manner that two fixed movement units are formed, which are movable in a mirror-symmetric manner at two movement axes in each case within a movement plane, such that it is possible to move between a closed state, in which the solar collectors touch in pairs in each case, and an open state, in which the pairs of solar collectors are arranged mirror-symmetrically with respect to one another in an essentially parallel alignment. Further, the movement axes are arranged normal to the movement plane and the actuator is configured to move the two movement units between the closed state and the open state mirror in a symmetric manner along predetermined paths.

In particular, a movement unit may be formed from a holding device and from solar collectors, e.g. one, two, three or four, which connect in pairs to the collectors of the second movement unit in the closed state. In particular, the opening and closing mechanism may be formed from two holding devices, the actuator, and the movement axes. For example, it may be that the movement axes are also part of the holding apparatuses. In particular, the movement axes may therefore be representational axes or guides.

For example, the solar collectors may be coupled to accommodation elements of the holding device or be accommodated by the same.

For example, the solar collectors may be constructed in a key-like manner or in the shape of a truncated pyramid, wherein edges of the solar collectors touch each other in the closed state in such a manner that a closed space can be formed.

Preferably, edges of the solar collectors comprise seals. It may be possible by means of such seals at the edge of the solar collectors that in the closed state, a sealed space can be provided by means of the pair of solar collectors.

In particular, the actuator may be configured to carry out a lifting movement which is carried out along a movement axis for example.

In particular, it may thus be possible to keep the center of gravity of the solar collectors predominantly in the horizontal during the movement for opening and closing (slight change in potential energy). According to the principle of virtual displacement, it can be deduced that the adjustment forces via the drives and furthermore the forces on rotary joints and support apparatuses may be kept low.

Further embodiments of the solar collector system will be described in the following.

According to an exemplary embodiment of the solar collector system, the opening and closing mechanism comprises at least one joint, which is attached in a movable manner at at least one of the movement axes such that the solar collectors carry out a rotation during the movement from the open state to the closed state. In particular, the rotation may be a 90° rotation.

According to an exemplary embodiment of the solar collector system, the opening and closing mechanism comprises two guides, by means of which the movement paths are defined.

In particular, the guides can be formed by means of pendulum supports and/or linear guides. For example, one guide may be a linear guide, whereas the second guide is formed by means of a pendulum support. Alternatively, both guides may be formed by means of linear guides. The linear guide may be formed by means of an axis, which can optionally comprise stops. In the case that linear guides are provided, one or a plurality of the linear guides may be formed by means of a double guide. The provision of a double guide, for example two axes located next to one another, may lead to a better guiding, for example by preventing tipping or twisting along the linear guides.

According to an exemplary embodiment of the solar collector system, the linear guide of the joints for the movement along one of the movement paths is realized by means of double guides. In particular, a movement path can be realized by means of double guides, which in the exemplary design experiences a pure back and forth movement, so that the initial position and the end position coincide.

According to an exemplary embodiment of the solar collector system, the guide of the joints for the movement along one of the movement paths is realized by means of pendulum supports. In particular, a movement path can be realized by means of double guides, which in the exemplary design experiences a pure back and forth movement, so that the initial position and the end position coincide.

According to an exemplary embodiment of the solar collector system, the actuator is a spindle drive. In particular, a movement axis may be a part of the axis drive. For example, the one movement axis may be the spindle of the spindle drive. Alternatively or additionally, a hydraulic drive may be provided.

According to an exemplary embodiment of the solar collector system, the solar collector system comprises four solar collectors, which can be moved between the open state and closed state by means of an individual actuator. Therefore, in particular, only one individual or a single actuator may be provided for the four solar collectors.

In particular, the solar collector system may comprise a multiple of four solar collectors, for example eight or sixteen solar collectors. Preferably, four solar collectors are combined in each case to form a group or a module on an opening and closing mechanism, which solar collectors can be moved by means of one individual common actuator.

According to an exemplary embodiment of the solar collector system, the solar collector system further comprises at least one tracking unit and is configured in such a manner that the solar collectors can be tracked to a position of the sun.

In particular, a tracking unit with two tracking axes may be provided, which enable tracking along directions that are perpendicular to one another. For example, one of the tracking axes can be suitable for taking a horizontal movement of the sun into account, whilst the other tracking axis enables a tracking with respect to the height of the sum's orbit path. In other words, one tracking axis may allow for an azimuth movement and the other allows for a zenith movement. It should be noted that the tracking unit is to be differentiated from the closing mechanism. Whilst the closing mechanism is used in particular to move two solar collectors against one another in such a manner that they can be transitioned from the open state to the closed state and vice versa, whereas a potential tracking unit is configured to align the solar collectors to a position of the sun that has changed in the course of the day respectively of the year. Such a potential tracking unit therefore does not form a necessary part of a closing mechanism.

According to an exemplary embodiment of the solar collector system, at least one tracking axis comprises an elastic element, which is configured to compensate forces, which arise during the tracking, at least to some extent. In particular, the forces may arise due to a change in center of gravity during the tracking. For example, the elastic element may be a spring or a pneumatic or hydraulic system.

According to an exemplary embodiment of the solar collector system, the solar collector system furthermore comprises a cleaning system, which is attached in the solar collector system in such a manner that in the closed state, the cleaning system is located between the solar collectors of a pair of solar collectors.

For example, the cleaning system may comprise a cleaning unit for each pair of solar collectors, which cleaning unit may for example be formed by an individual nozzle or a ring of nozzles and which cleaning unit is located next to the solar collectors of a pair of solar collectors in the open state, whilst in the closed state, the same is located within a space, which is enclosed by the solar collectors of one pair.

According to an exemplary embodiment of the solar collector system, the cleaning system is rigidly fastened at the solar collector system.

In this connection, the term “rigidly” may in particular mean that the cleaning system does not move or rotate during the movement between the open state and the closed state.

According to an exemplary aspect, a solar collector system with an opening and closing mechanism may be provided, which is characterized in that solar collectors and holding apparatuses form fixed movement units, which are arranged mirror-symmetrically in pairs and in each case can be rotated by ±90° via two axes arranged fixedly at the movement units, which are aligned normal to the movement plane, in predetermined paths of a support apparatus or of the holding apparatuses via the lifting movement of an actuator.

In other words, it may thereby be achieved that solar collectors and holding apparatuses form fixed movement units, which may be arranged mirror-symmetrically in pairs and may be attached via displaceable joints to a support apparatus, which is in turn fixedly or movably attached to a supporting frame. Each movement unit is mounted in a displaceable manner via in each case two spatially parallel axes at right angles to the movement plane in guide paths predetermined by the support apparatus. The individual rotary joints at the movement units may be positively guided in different paths via linear guides or pendulum supports, which are anchored at the support apparatus, so that a 90° rotation can be realized by means of a lifting movement of a hydraulic apparatus or a spindle drive.

A rotation of ±90° for each movement unit results during the movement from the open to the closed state and vice versa, with a small change of the vertical position of the center of gravity. Due to the mirror-symmetrical arrangement of the two movement units, collector pairs closed at the mirror ends can be brought to the open state with the same alignment by means of the equal and opposite rotation by ±90° into the open state, without the center of gravity of the movement units being significantly displaced.

Specifically, according to exemplary embodiments, a mechanism may be provided, which provides a linear guide (first guide) for the axes of the individual movement units in each case and a further guide (second guide) arranged mirror-symmetrically to the first guide, which second guide specifies a path which runs approximately normal (±30° deviation) to the direction of the first guide. Ideally, the connecting line of the two rotary joints of each movement unit in the end positions (open or closed, or open state and closed state) has an angle of ±45° to the direction of the first guide. In this manner, the collectors realize the desired angle of ±90° when opening and closing. Joints in the second guide experience a pure back and forth movement in this configuration, so that the initial position and the end position coincide. This may provide the option to delimit the desired ±90° rotation of the two movement units between open and closed collector position via stops in the second guide. A further option for delimiting the movements to the ±90° rotation results in that stops are provided in the first guide. For realizing the movements, the joints can for example be driven in the first guide. This can take place by means of a spindle drive or a hydraulic sliding system, at which the joints are mounted. Spindle drives or hydraulic sliding systems form a part of the support apparatus and predetermine the direction of the first guide. The two paths of the first guide can be provided at a certain spacing from the center line of the hydraulic or the spindle unit or else coincide on the center line. The joints of the first guide therefore move along two parallel guide lines or along a common guide line. The axes can in this case be formed by means of actual units in particular.

According to a further additional or alternative exemplary aspect, solar collector systems or collector installations can be provided, which are equipped with opening and closing modules, which in each case consist of four collectors, two holding apparatuses and a support apparatus with drive and connecting devices. Depending on the design of the collector installations, one or a plurality of support apparatuses are either mounted fixedly at supporting frames or are attached to the same via rotary joints. The supporting frames are tracked to the sun mono- or bi-axially.

According to a further exemplary aspect, a fixedly fastened cleaning device is attached at the supporting apparatus. This for example positions two rings equipped with cleaning nozzles (cleaning rings) in the mirror plane of the movement units which are arranged in pairs. Ideally, the centers of the cleaning rings are positioned on the axes of the rotationally symmetrical mirror collectors, which encompass the same in the closed state. This position of the cleaning rings makes it possible that in the open state, no shading onto the capture surfaces of the mirrors takes place and that no collisions take place during the opening and closing of the collectors. The cleaning rings can also be mounted in a rotatable manner or in a pivotable manner. The rotation takes place in the closed state of the collectors during the cleaning procedure. It is conceivable, instead of the cleaning rings, to provide other nozzle carriers also, such as for example a linkage system or a spherical nozzle arrangement (nozzle head). In order to prevent collisions at the supporting rods of the nozzle carriers, the mirrors are designed recessed at retraction points for the supporting rods of the nozzle carriers. The retraction points at the collectors are preferably at the deepest position of the mirrors in the closed state. Thus, the cleaning water can flow away to the outside via openings towards the supporting rods respectively can be captured for re-use. The sealing rubbers at the mirror ends can preferably also constitute a sealed encompassing at the retraction points for the supporting rods. Thus, it may be better possible to preheat the mirrors using water vapor and to leave the vapor to dissolve dirt for a certain time, before the rinsing procedure starts. With this method, the water consumption may be minimized, a gentle cleaning may be ensured, and the dirty water can be captured optimally.

The hydraulic pressure in the cleaning system (5-10 bar) is sufficient to operate a hydraulic drive or the hydraulic cylinder thereof for the opening and closing of the collectors. As the thrust may be kept to a minimum on the basis of the present kinematics, a small cross section of the pressure cylinder is to be preferred, which may minimize the discharge loss during the sliding movements. This water also can of course be captured.

Thus, a solar collector system may be provided, which comprises an opening and closing mechanism for solar collectors arranged in pairs, wherein the paired solar collectors are able to close together with respect to one another. In particular, different designs of modularly constructed collector systems with bi-axial tracking and optionally built-in cleaning mechanism can be developed. In this specific case, rotationally symmetrical solar collectors, for example mirror collectors, are considered here, which may form a delimited space by means of the closing together in pairs. With the closing together of the collectors at the outer mirror ends it is achieved that sensitive components such as mirrors, absorbers or solar cell modules are protected from damaging environmental influences and from soiling. In addition, the option may be given to install cleaning systems, so as to be able to advantageously use the closed state with the delimited and ideally also sealed interior space for an optimum cleaning with a low water consumption, if required also with the capture of the dirty water. Furthermore, a design is also be shown, which makes it possible to modularly configure bi-axially tracked collector units of different sizes equipped with four to sixteen collectors and to provide the option for the installation of a cleaning mechanism, even on the basis of retrofitting.

Further advantages and features of embodiments of the present invention result from the following exemplary description of currently preferred embodiments. The individual Figures in the drawing of this application are merely to be seen as schematic.

### BRIEF DESCRIPTION OF THE FIGURES

Further features and details of embodiments of the present invention result from the following description of the Figures. In the Figures:

FIG. 1 shows a schematic illustration of the kinematic system for the movement by 90° in the movement plane.

FIG. 2 shows a schematic illustration of a collector system, which is used here, with the course of the change of the center of gravity when opening and closing the collectors.

FIG. 3 shows a first design variant for an opening and closing module with four collectors.

FIG. 4 shows a second design variant for an opening and closing module with four collectors.

FIG. 5 shows a third design variant for an opening and closing module with four collectors.

FIG. 6 shows a fourth design variant for an opening and closing module with four collectors.

FIG. 7 shows a design variant of a collector unit with an opening and closing module for four collectors according to the image in FIG. 4, which is rotatably attached or fastened at a supporting frame, which is driven about a further axis.

FIG. 8 shows a design variant of a collector unit with an individual opening and closing module for four collectors according to the image in FIG. 5, which is attached or fastened at a supporting frame, which is driven about a further axis.

FIG. 9 shows a further design variant of a collector unit with a single opening and closing module for four collectors, which is fixedly attached or fastened to a supporting frame, which is bi-axially tracked about a vertically and horizontally aligned axis.

FIG. 10 shows a further design variant of a collector unit with two opening and closing modules for four collectors in each case, which are attached or fastened via rotary joints at a supporting frame, which is tracked mono-axially.

FIG. 11 shows a further design variant of a collector unit with two opening and closing modules for four collectors in each case, which are fixedly attached or fastened to a supporting frame, which is bi-axially tracked about a vertically and horizontally aligned axis.

FIG. 12 shows a further design variant of a collector unit with four opening and closing modules for four collectors in each case, which are fixedly attached or fastened to a supporting frame, which is bi-axially tracked about a vertically and horizontally aligned axis.

FIG. 13 shows a design variant of a collector unit with a single opening and closing module for four collectors, which is attached or fastened to a fork-shaped supporting frame via a horizontally aligned tracking axis.

FIG. 14 shows more in-depth details about the stopping from FIG. 13.

FIG. 15 shows a schematic illustration of the kinematic system according to a further variant of a collector unit with an opening and closing mechanism.

### DETAILED DESCRIPTION OF THE FIGURES

Exemplary embodiments of the invention are described in the following with reference to the Figures, wherein mirror-symmetrical, identical or similar elements or parts with identical function being designated with identical or similar reference numbers in the various Figures.

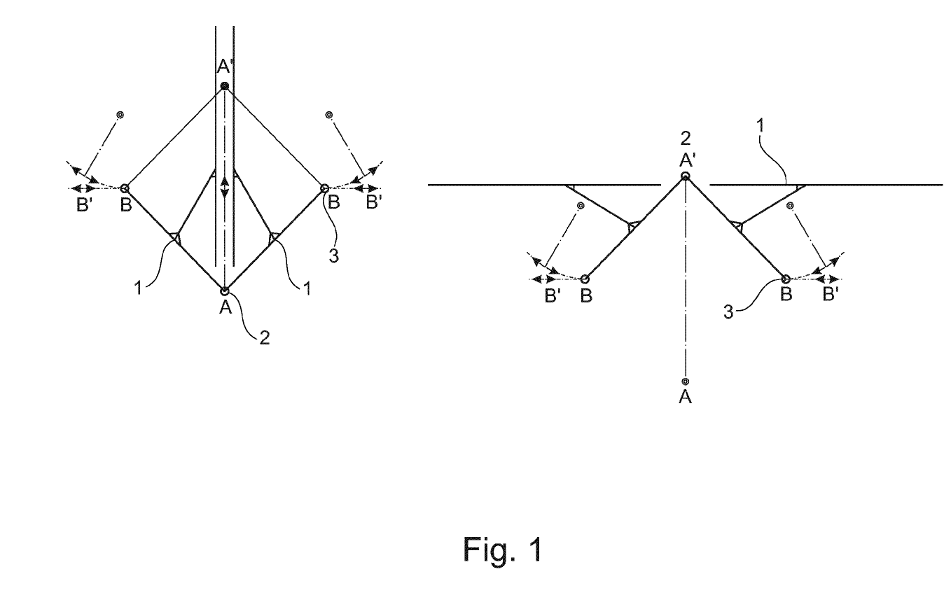

FIG. 1 shows a schematic illustration of the kinematic system for the movement by 90° in the movement plane. Mirror-symmetrically arranged movement units 1 are only illustrated in a greatly schematized manner for the sake of clarity. The movement units 1 are mounted at joints 2 and 3. The joints 2 are moved from A to A′ in a first guide during the movement from the closed state to the open state. The guide lines for the joints 2 coincide in FIG. 1 for both movement units 1, but can also be separate. The joint in a second guide executes a back and forth movement, wherein initial and end position coincide. As shown here in the closed state, this results in that the connecting line for the joints 2 and 3 encloses an angle of 45° to the guide line from A to A′. Thus, one has the option of delimiting the rotational movement of the movement units 1 to the desired ±90° by means of stops for the joints 3 on the second guide. The second guide can have any desired path. This can best be realized in terms of design, as shown here, by means of a linear guide or a part of a circular path.

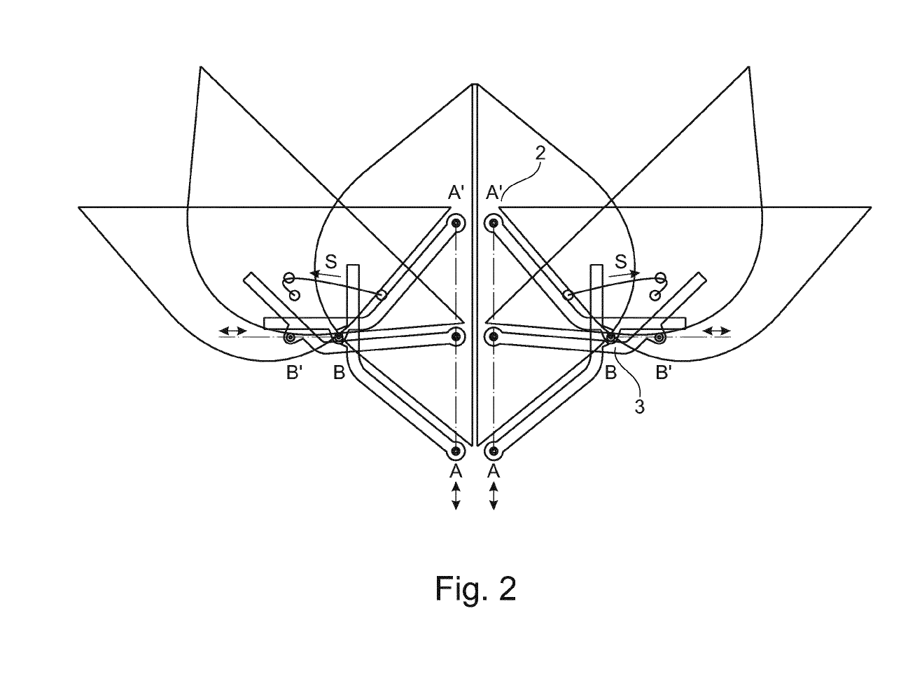

FIG. 2 shows a schematic illustration of a collector system, which is used here, with the course of the change of the center of gravity when opening and closing the collectors. Three collector positions from closed to the open state with the rotations 0°, ±45° and ±90° about the joints 2 and 3 are shown. The joint 3 is pushed back and forth along a straight line. The maximum deflection from B to B′ exists at the rotation of ±45°. It is decisive that the centers of gravity S of the movement units 1 experience a minimal vertical deflection during the ±90° rotation or displacement from A to A′, as can be seen from the movement paths. The straight guide lines from A to A′ for the joints 2 are parallel and have an offset with a certain spacing. This may have the advantage that the joints 2 on the movement units 1 can be positioned at the same height vertically as the lowest points of the collector edges in the closed state, the collectors enclosing a necessary spacing in the open state. In particular, the consequence of this is that the centers of gravity of the movement units 1 can assume a more beneficial position. It is also conceivable to balance the system accordingly, in order to again optimize the position of the center of balance.

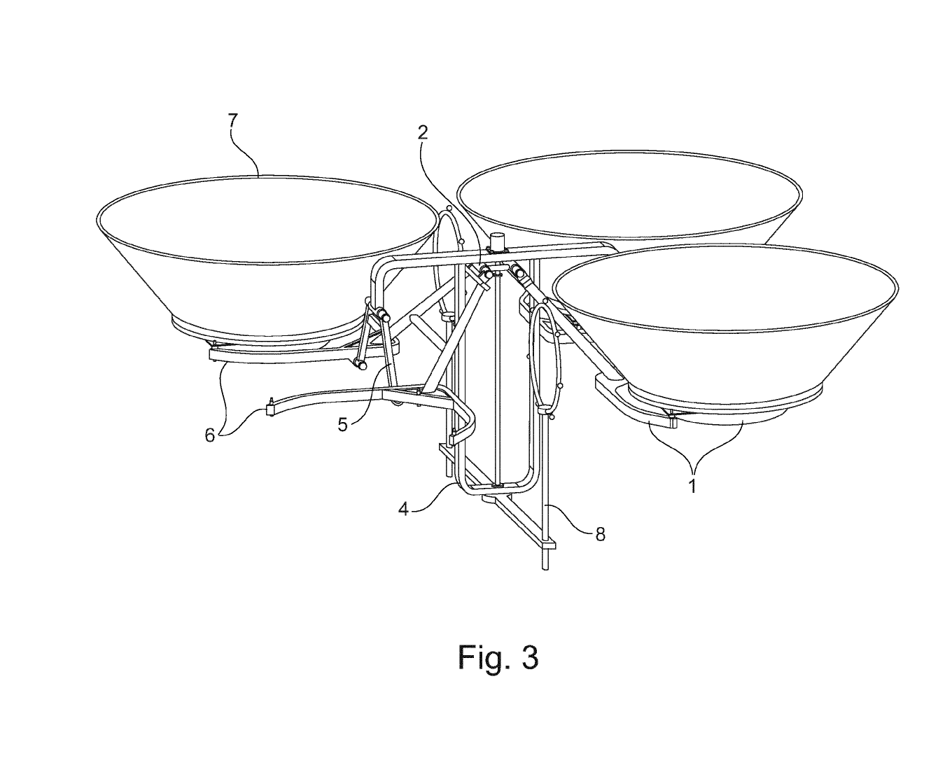

FIG. 3 schematically shows a first design variant for an opening and closing module or opening and closing mechanism with four collectors. The guide paths B to B′ are predetermined by means of two pendulum supports 5. The joints 2 are moved by means of an open spindle drive, which is mounted on both sides in a support apparatus 4. The support apparatus 4 has two stops for the open and closed state in each case and is realized in a stable box design. A cleaning mechanism 8 is fixedly or rigidly connected at the support apparatus 4. Holding apparatuses 6 carry two collectors 7 in each case. A stable spatial position of the movement units 1 (two collectors 7+one holding apparatus 6) is realized by means of the joints 2 and 3.

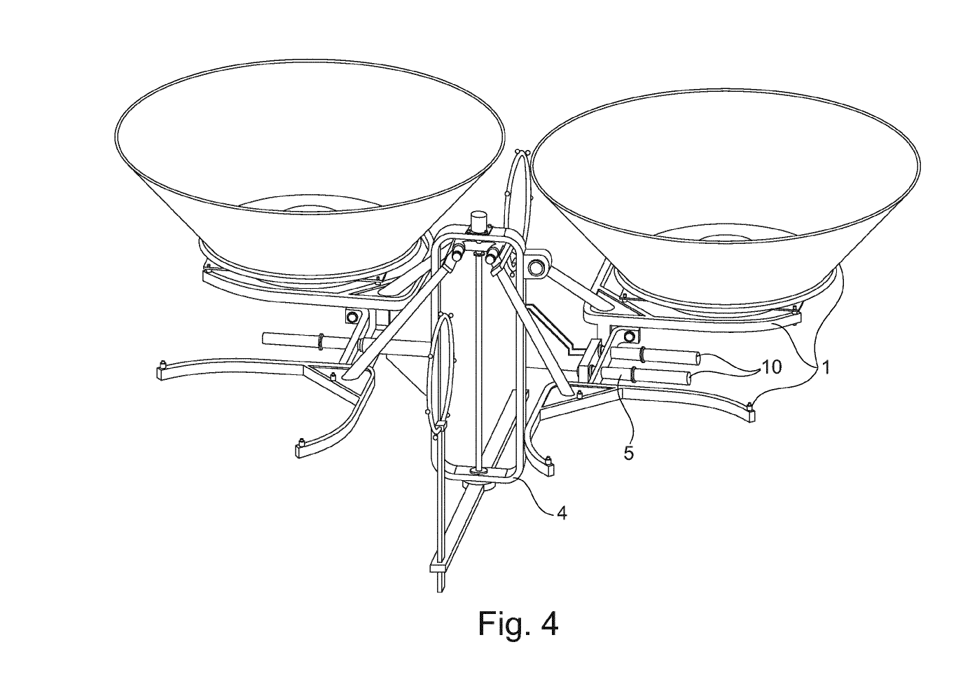

FIG. 4 schematically shows a second design variant for an opening and closing module with four collectors. In contrast with the previous variant, the guide paths B to B′ are predetermined via linear guides. The movement units 1 are prevented from rotating by means of the arrangement of a double guide on a side of the support apparatus 4 and a simple guide (no absorption of rotational forces). A moving slide 5 (replacement for pendulum supports) has a stop for the support apparatus 4 for the end positions. The double guide 10 is advantageous, as in the case of an opening angle of ±45°, the system otherwise comes to a wobbly position in this position. At the end stops of the spindles A and A′, a rotationally secure position is given solely by means of the lateral support on the spindle.

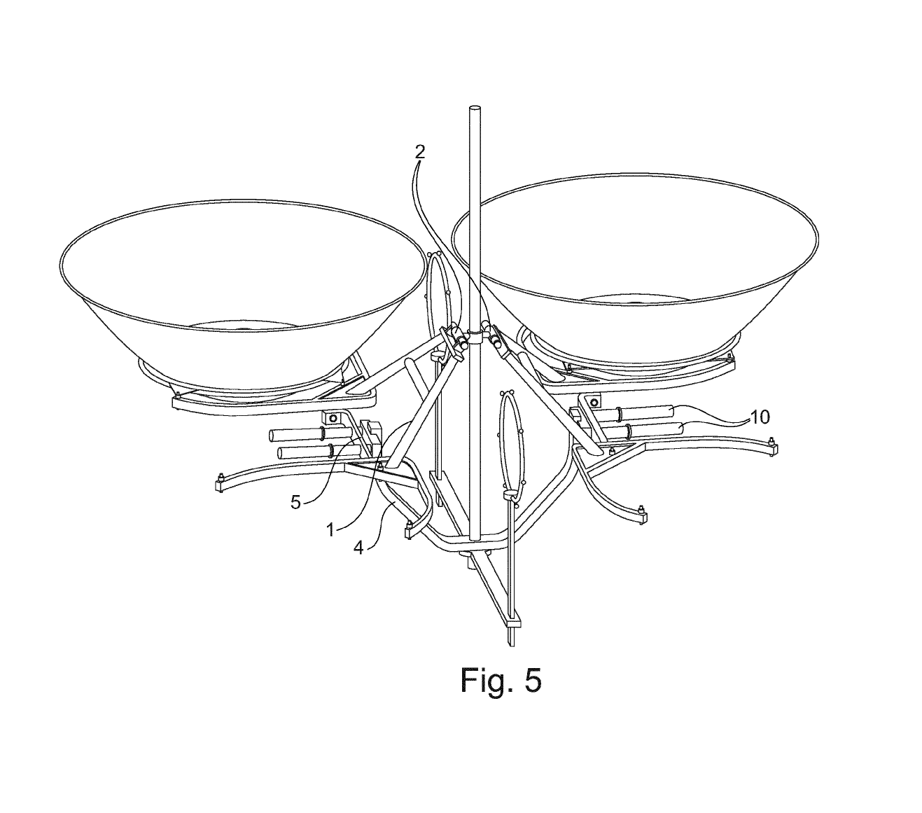

FIG. 5 schematically shows a third design variant for an opening and closing module with four collectors. Just as in FIG. 4, the guide paths B to B′ are predetermined via linear guides. The movement units 1 are prevented from rotating by means of the arrangement of double guides 10 on both sides of the support apparatus 4. The moving slide 5 (replacement for pendulum supports) has a stop for the support apparatus 4 for the end positions. The joints 2 are held in the open state by a spindle unit or hydraulic unit, which is mounted in a floating manner, and therefore provide little protection against rotation. These forces are absorbed by the double guides 10. Lateral deflection forces are absorbed by the stops of the movement slides 5.

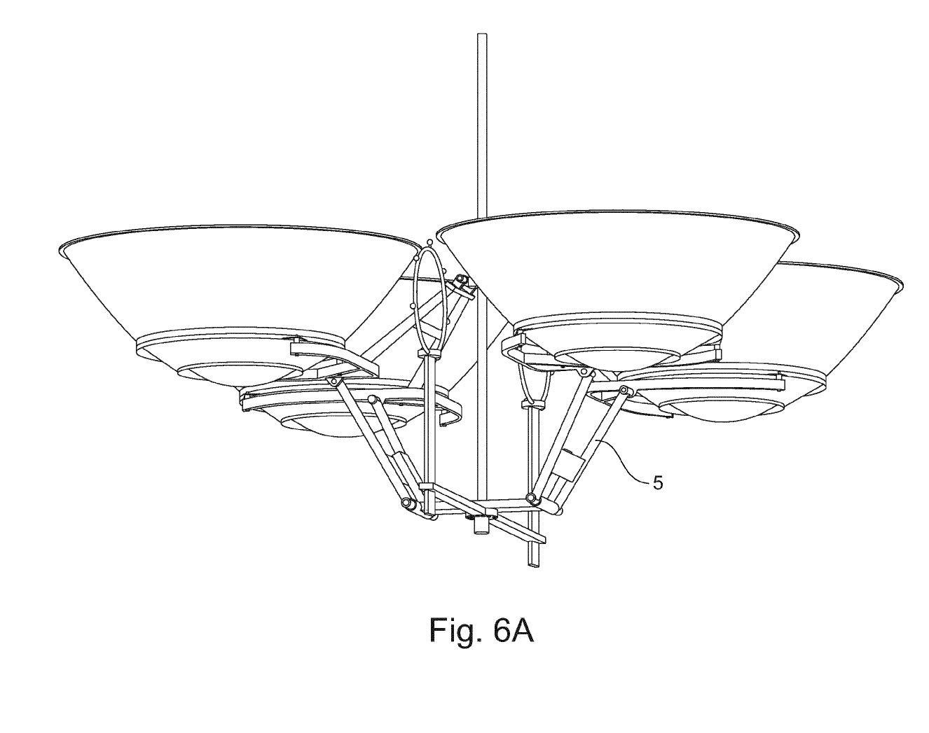

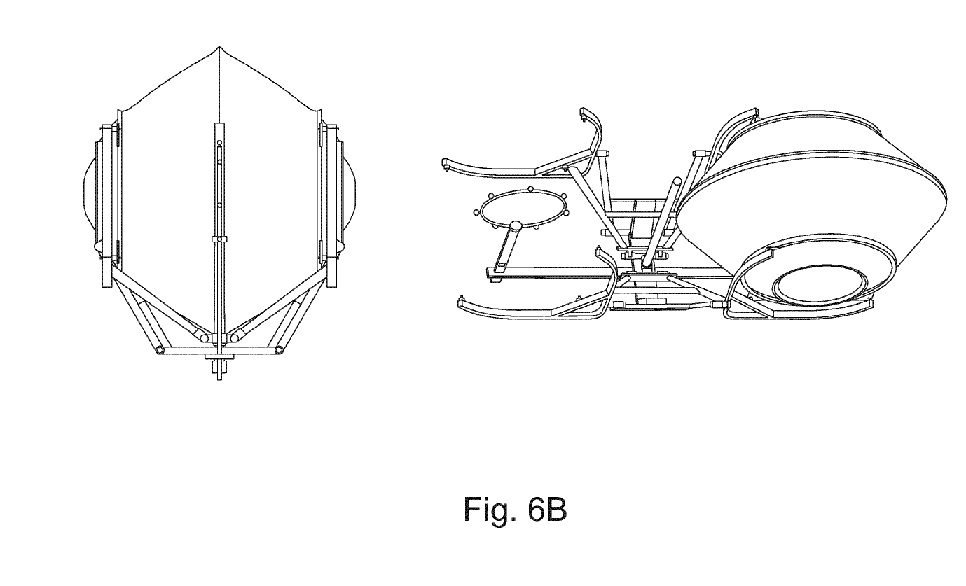

FIG. 6A schematically shows a fourth design variant for an opening and closing module with four collectors. The displacement of the joints 3 is enabled by means of pendulum supports 5 that are located below. The spindle or hydraulic unit is mounted in a floating manner. With this design, it may be possible to minimize a vertical displacement of the center of gravity again during opening and closing.

FIG. 6B schematically shows the device of FIG. 6A in the closed state, in which a pair of collectors are closed together at the edges.

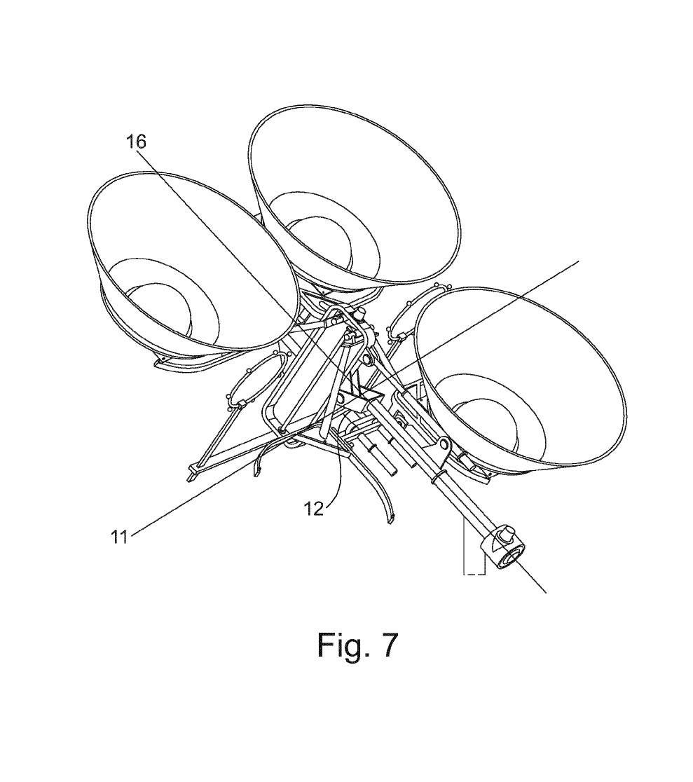

FIG. 7 schematically shows a design variant of a collector unit with an opening and closing module for four collectors according to the image in FIG. 4, which is attached in a rotatable manner about an axis 11, here termed “first tracking axis”, at a supporting frame 12, which is driven about a further axis 16. Attached to the supporting frame 12 and support apparatus 4 are the joint receptacles for a spindle drive 13 (alternatively hydraulics or pneumatics). Ideally, the rotational axis 16, about which the supporting frame 12 rotates, here termed “second tracking axis”, is aligned parallel to the axis of the earth. In this case, it is sufficient if the first axis is set to the seasonal position of the ecliptic once or twice per day. The maximum rotation is ±23.5°. The daily tracking can take place in a minute cycle, solely by rotating about the second tracking axis 16. The suspension of the opening and closing module ideally takes place, as can be seen from the design, tared about the second rotational axis 16 according to the center of gravity. The adjustment forces of the drive can be minimized as a result. As rotation is only carried out about the second tracking axis 16 for the daily tracking, the energy and cost outlay for the tracking is kept low.

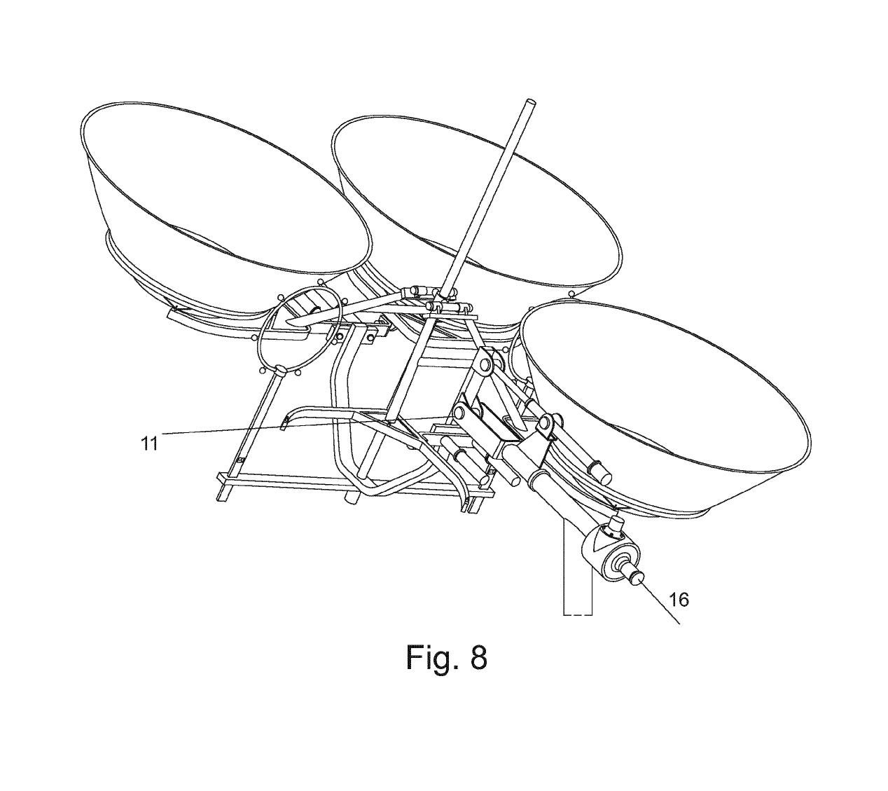

FIG. 8 schematically shows a further design variant of a collector unit with a single opening and closing module for four collectors according to the image in FIG. 5, which is attached in a rotatable manner about the first tracking axis 11, at a supporting frame 12, which is driven about an axis 16. If the second tracking axis 16 is aligned parallel to the axis of the earth, the same advantages result as already described in connection with FIG. 7.

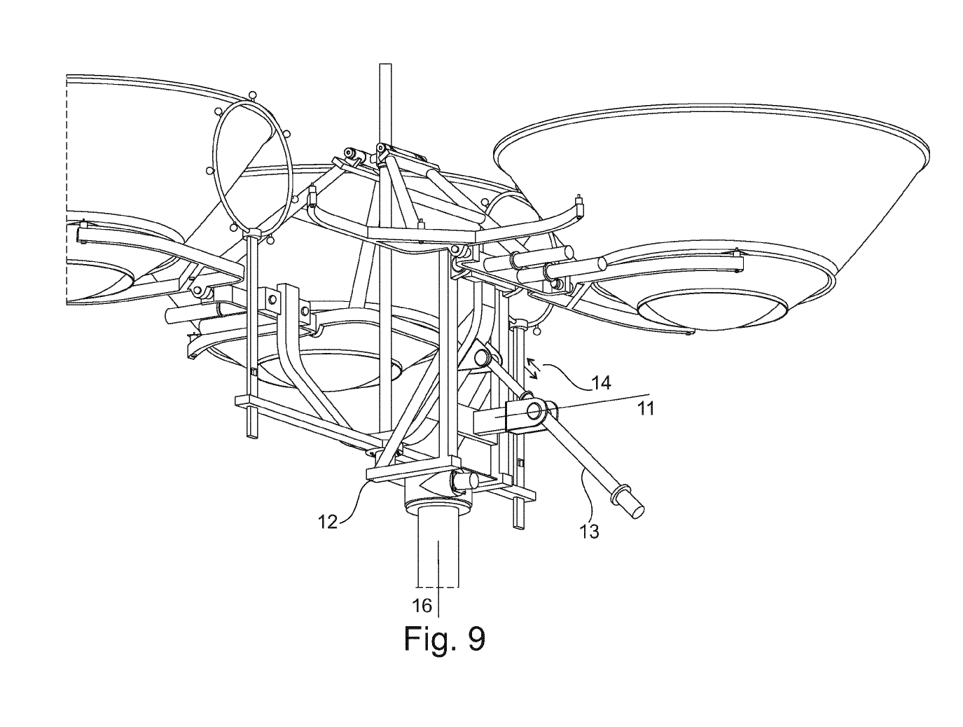

FIG. 9 schematically shows a further design variant of a collector unit with a single opening and closing module for four collectors according to the image in FIG. 5, which is attached in a rotatable manner about an axis 11, here termed “first tracking axis”, on a supporting frame 12, which is tracked mono-axially. Attached to the supporting frame 12 and support apparatus 4 are the joint receptacles for a spindle drive 13 (alternatively hydraulics or pneumatics). The first axis is positioned horizontally on the supporting frame. The supporting frame 12 is mounted in a rotatable manner about the second axis, which is aligned vertically. The rotation about the first axis is realized via a spindle drive 13 (alternatively hydraulics or pneumatics). Considerable forces are necessary here, as the collector system is tared about the horizontal axis, but not according to the center of gravity. In the case of a 90° rotation, the center of gravity changes its action on the spindle load from a pushing position to a pulling position. In total, the work performed by the rotation by 90° is almost zero. In order to lower the force on the spindle or the drive, there is the option to install a spring 14, which substantially eliminates the pulling and pushing on the spindle. This spring 14 can be installed optimally at the spindle drive 13. Thus, it is also possible here to track in a relatively energy-saving manner, even though both adjustment motors readjust in short intervals or constantly.

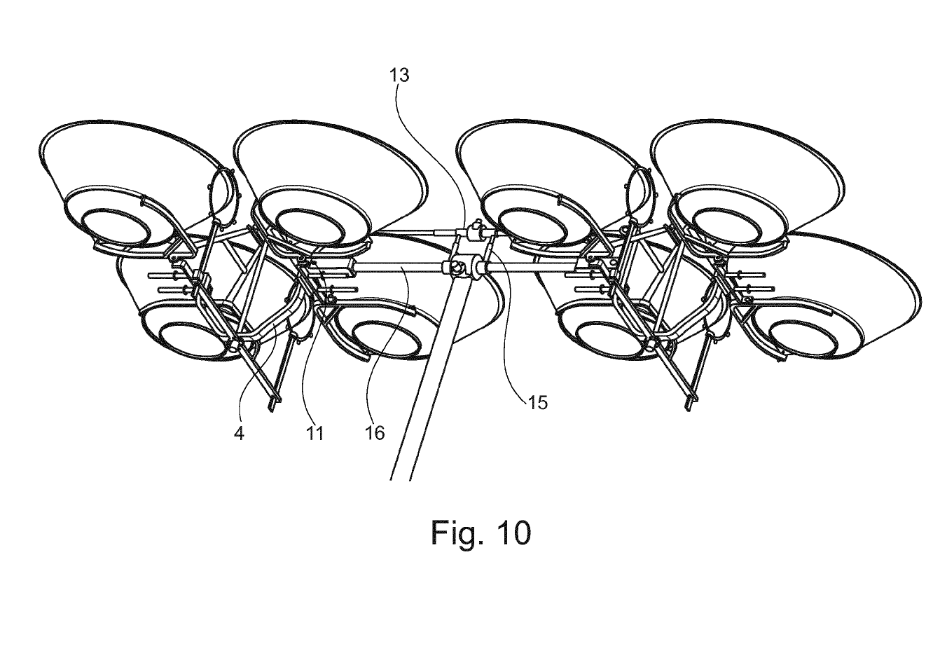

FIG. 10 schematically shows a further design variant of a collector unit with two opening and closing modules for four collectors according to FIG. 5 in each case, which are attached via rotary joints to a supporting frame 12, which is tracked mono-axially. A variant is shown with a spindle drive 13 with a push rod emerging on both sides. In order to compensate the height change during the rotation of the collectors, the spindle drive 13 is mounted in a double guide 15 at the supporting frame. The joint connections for the push rod must be positioned at the support apparatus 4 with the same spacing from the center line as the first tracking axis 11. Thus, it is enabled in a simple manner that both opening and closing modules have the same rotational deflection in every position. As the opening and closing modules exert equal and opposite forces on the push rod, the spindle load is always kept low. Thus, it is possible to track in an energy-saving manner using small adjustment motors, even though both adjustment motors readjust in short intervals. In order to avoid a mutual shading of the collectors in the case of larger deflections about the first tracking axis 11, this axis 11 must be positioned sufficiently far from the center point or center of gravity of the opening and closing modules. Thus, both opening and closing modules execute a lifting and lowering movement in an equal and opposite manner. In the case of an alignment of the second tracking axis 16 parallel to the axis of the earth, as already described in detail in connection with FIG. 7, the daily rotation can be executed substantially alone via the adjustment motor for the second tracking axis.

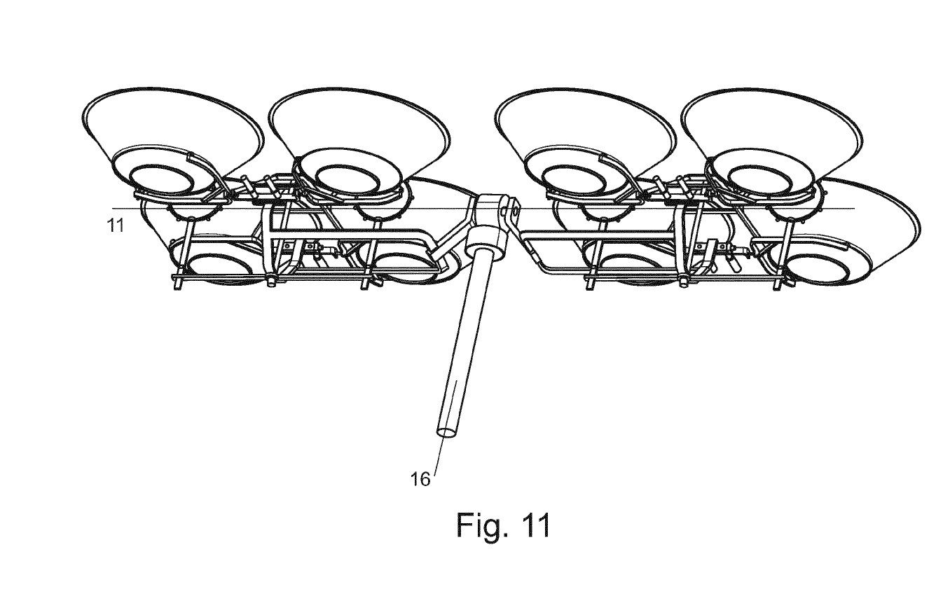

FIG. 11 schematically shows a further design variant of a collector unit with two opening and closing modules for four collectors according to FIG. 5 in each case, which are fixedly attached to a supporting frame, which is bi-axially tracked about vertically and horizontally aligned axes 11 and 16. The axes are located in the centers of gravity in order to minimize the rotational forces.

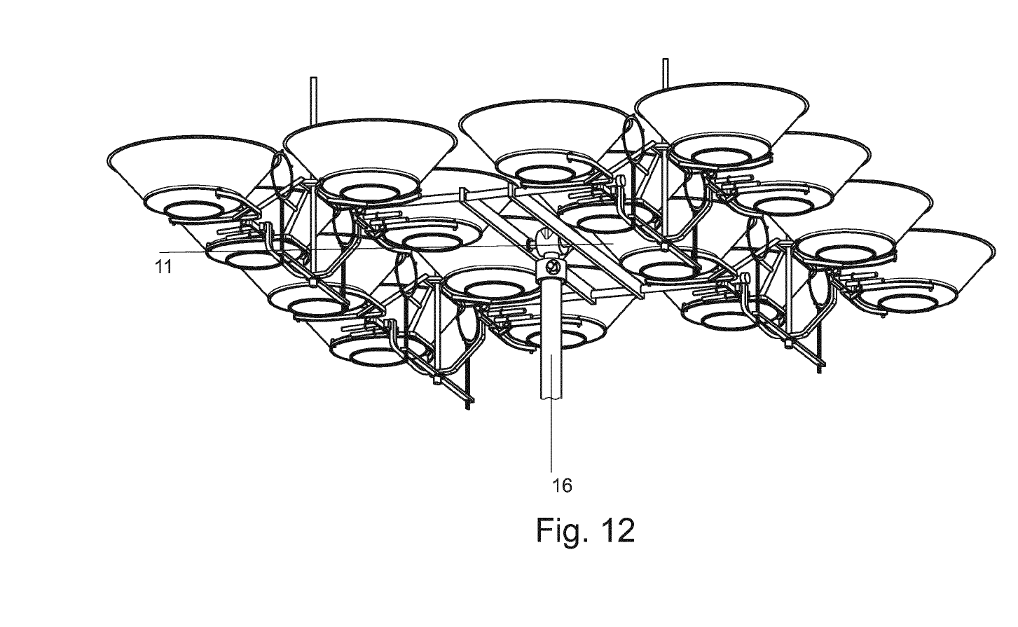

FIG. 12 schematically shows a further design variant of a collector unit with four opening and closing modules for four collectors in each case, which are fixedly attached to a supporting frame, which is bi-axially tracked about a vertically and a horizontally aligned axis 11, 16. The axes are located in the centers of gravity in order to minimize the rotational forces respectively the rotational torques.

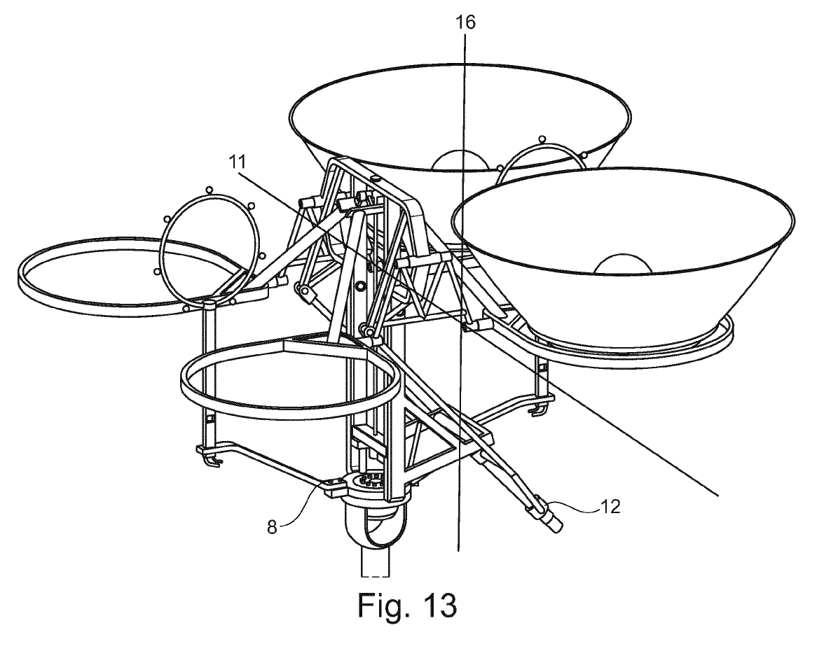

FIG. 13 schematically shows a design variant of a collector unit with a single opening and closing module for four collectors, which is attached or fastened to a fork-shaped supporting frame 12 via a horizontally aligned tracking axis 11, which supporting frame is in turn tracked mono-axially about a vertically aligned axis 16. The first tracking axis 11 is positioned rotated by 90° with respect to the above shown opening and closing modules. The cleaning mechanism 8 is fixedly mounted at the supporting frame 12. During the pivoting of the collectors about the first tracking axis 11, no collision with the cleaning mechanism 8 results. During the opening and closing of the collectors, the tracking must proceed to the neutral position (illustration shown in FIG. 13), in order to prevent collisions and in order to position the cleaning nozzles in the desired location with respect to the collectors. The first tracking axis 11 is ideally, as can be seen here, located in the center of gravity of the system.

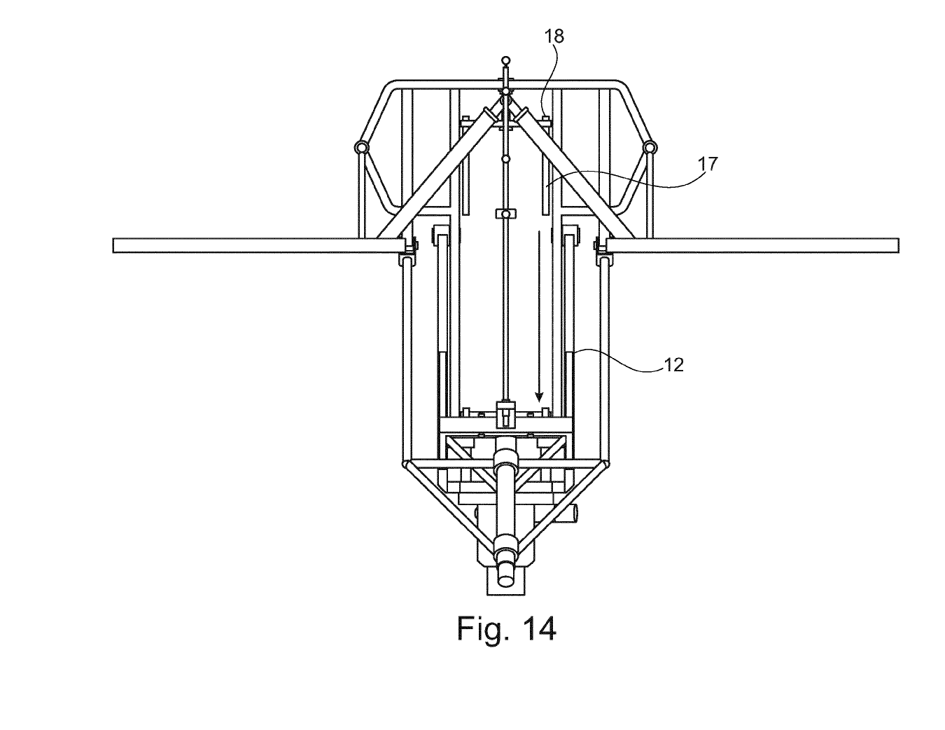

FIG. 14 schematically shows a particular detail from FIG. 13 for stopping or limiting the movements about the first and second tracking axis 11, 16. In the neutral position, bolts 17, which are fastened at the joint receptacles or posts 18 of the spindle, are retracted into receptacles at the supporting frame 12 during the closing of the opening and closing module. These bolts are pushed into receptacles of the rotating apparatus at the post 18. Thus, the rotation is blocked at both tracking axes 11, 16. This stopping protects the drive systems from strong retaining forces e.g. wind forces, in the closed state.

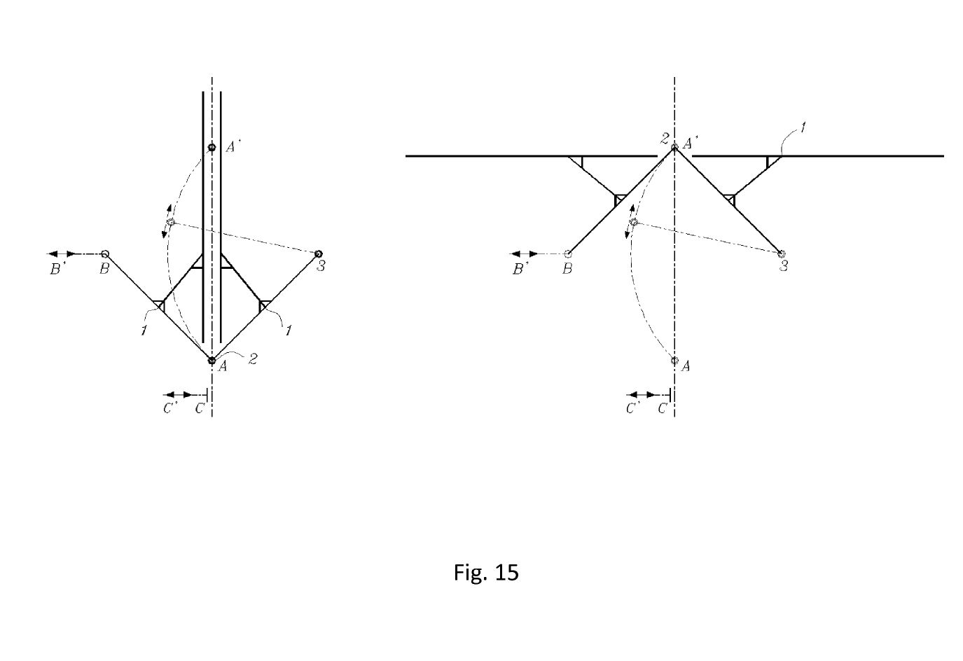

FIG. 15 shows a schematic illustration of the kinematic system according to a further variant of a collector unit with an opening and closing mechanism. In particular, FIG. 15 shows a collector unit 1 in a closed position (left) and an open position (right). In contrast with the kinematic system of FIG. 1, in the kinematic system of FIG. 15, one of the movement axes or joints 3 is fixedly arranged at the support apparatuses (the one arranged on the right in FIG. 15), whilst the other (left in FIG. 15) is mounted in a horizontally displaceable manner. This horizontal displacement is indicated in FIG. 15 by the line BB′. The line AA′ indicates, as in FIG. 1, the movement of the joints 2 in a guide or movement axis from the closed state (FIG. 15 left) to the open state (FIG. 15 right). In the movement between the two states, it is to be taken into account that, when one considers the system of FIG. 15 with respect to the plane of symmetry, both collectors in turn move in a mirror-symmetric manner to the plane of symmetry. The plane of symmetry is placed during the movement of the joint 2 horizontally along the associated axis or guide (from A to A′). This horizontal displacement is indicated by an indicated movement from C to C′ and back in FIG. 15. During the displacement of the joint 2 along the guide (from A to A′), the joint 2 therefore moves along a circular path, which is likewise drawn in for the sake of understanding in FIG. 15. Therefore, (as in the previously realized exemplary embodiments), in the collector system of FIG. 15, the mirror-symmetrically arranged collector pairs are moved exactly identically or mirror-symmetrically with respect to one another, which likewise leads to the above-mentioned advantages.

In summary, according to an exemplary embodiment, an opening and closing module for solar collector installations may be provided, in which solar collectors and holding apparatuses form fixed movement units, which are arranged in a mirror-symmetric manner in pairs and are attached via displaceable joints to a support apparatus, which is fixedly or movably attached to a supporting frame. The individual rotary joints at the movement units are positively guided via linear guides or pendulum supports, which are anchored at the support apparatus.

Embodiments of the invention are not only limited to the variants presented here, but rather also to obvious combinations that can be derived therefrom. In the case of the features according to embodiments of the invention that are schematically illustrated in all Figures, it should be pointed out that the individual components can be manufactured in all diverse design variants and materials. In addition, it is to be pointed out that “comprising” does not exclude any different elements or steps and “a” or “an” does not exclude a multiplicity. Furthermore, it may be pointed out that features or steps, which have been described with reference to one of the above exemplary embodiments, can also be used in combination with other features or steps of other above described exemplary embodiments. Reference numbers in the claims are not to be seen as limiting.

1. A solar collector system with an opening and closing mechanism, wherein the solar collector system comprises:
solar collectors;
an opening and closing mechanism with movement axes, an actuator and at least two holding apparatuses arranged mirror-symmetrically;
wherein the at least two holding apparatuses are configured to accommodate the solar collectors in such a manner that at least two fixed movement units are formed;
wherein the movement units are movable along the movement axes within a movement plane in such that the movement units are movable between a closed state, in which the solar collectors touch in pairs each other, and an open state, in which the pairs of solar collectors are arranged mirror-symmetrically with respect to one other in a parallel alignment;
wherein the movement axes are arranged normal to the movement plane;
wherein the actuator is configured to move the at least two movement units between the closed state and the open state along predetermined paths.

2. The solar collector system according to claim 1, wherein the opening and closing mechanism comprises a support apparatus, relative to which the joints at the movement axes of the movement units are movable in such a manner that the solar collectors carry out a ±90° rotation when moving from the open state to the closed state.

3. The solar collector system according to claim 1, wherein the support apparatus is attached in a fixed manner to a supporting frame, which is tracked via two axes.

4. The solar collector system according to claim 1, wherein the support apparatus is attached to a supporting frame in a movably mounted manner via an axis, which supporting frame is rotatably mounted via a further axis.

5. The solar collector system according to claim 1, wherein the opening and closing mechanism comprises two guides, by means of which the movement paths are defined.

6. The solar collector system according to claim 1, wherein the linear guide of the joints for the movement along one of the movement paths is realized by means of double guides.

7. The solar collector system according to claim 1, wherein the guide of the joints for the movement along one of the movement paths is realized by means of pendulum supports.

8. The solar collector system according to claim 1, wherein the actuator for opening and closing predetermines a linear guide path from A to A′.

9. The solar collector system according to claim 1, wherein the joints are positioned at a fixed distance with respect to a center line of the actuator.

10. The solar collector system according to claim 1, wherein the opening and closing mechanism accommodates four solar collectors, which can be moved between the open state and closed state by means of an individual actuator.

11. The solar collector system according to claim 4, wherein the at least one tracking unit comprises an elastic unit, which is configured to compensate forces, which arise during the movement for tracking, at least to some extent.

12. The solar collector system according to claim 1, which furthermore comprises
a cleaning system, which is attached in the solar collector system in such a manner that, in the closed state, the cleaning system is located between the solar collectors of a pair of solar collectors.

13. The solar collector system according to claim 12, wherein the cleaning system is rigidly fastened at the solar collector system.
